(19) United States
(12) Patent Application Publication
(10) Pub. No.: US 2007/0220252 A1
(43) Pub. Date: Sep. 20, 2007

(54) Interactive network access controller

(76) Inventor: Michael Joseph Sinko, Pleasantville, NY (US)

Correspondence Address: JLB CONSULTING, INC.;c/o INTELLEVATE, P.O. BOX 52050, MINNEAPOLIS, MN, 55402, US

(21) Appl. No.: 11/146,347

(22) Filed: Jun. 6, 2005

(51) Int. Cl. H04L 9/00

(52) U.S. Cl. 713/168

(57) ABSTRACT

Methods (400, 500) and systems (100, 600) for interactively controlling access to a communication network (102) are disclosed. In one embodiment, a user is queried (600) on whether to allow a communication device (118) to access the network (102) and the communication device (118) is allowed access if the user actively gives permission (506). In one embodiment, the methods and systems of this invention allow interactive Media Access Control MAC address filtering of communication devices (118) attempting to access the network (102), for example wireless communication devices.

### FIELD OF THE INVENTION

The present invention relates generally to the field of computer security and more specifically to the control of electronic network access.

### BACKGROUND OF THE INVENTION

Every network adaptor conforming to certain specifications such as for example the Ethernet specifications has a unique Media Access Control (MAC) address (also known as a physical address) which is typically allocated by the manufacturer. MAC address filtering allows for control of which network adaptors (as identified by corresponding MAC addresses) can access the controlled network, for example the Internet.

Wireless networking has become popular especially in the home computer market. In recent surveys, 75% of all wireless network access points had no security features enabled. The two most likely reasons are either that users did not have sufficient technical knowledge to enable a security feature or that the users did not want to compromise the ease of setup and use of the wireless access point.

In order to facilitate ease of setup and use of a wireless access point, manufacturers typically manufacture the wireless access point with default settings which allow any wireless device in range to connect to the wireless access point using the default settings.

Typically MAC address filtering is disabled as the default option for a wireless access point so that setup and use of a wireless access point is simplified. Enabling MAC address filtering for a wireless access point typically involves setting up an access control list comprising MAC addresses of all adapters which should be allowed to connect to the access point or conversely comprising MAC addresses of all adapters which should be denied access. In one configuration, in order to setup or edit an access control list, a user accesses a web interface by typing in the IP address of the wireless access point using a web browser, logs in with a username and password, and navigates subsequent web pages to access the MAC filtering page.

Current methods to set up MAC address filtering to protect access to a controlled network from a wired network or to protect access to a controlled network via a network device other than a wireless access point are similarly inconvenient.

### SUMMARY OF THE INVENTION

The present invention provides methods and systems for straight-forwardly facilitating a network owner/operator to control communications device access to an electronic network.

According to the present invention, there is provided a method of managing access to a restricted network, comprising: indicating to a user that a communication device is attempting to access the restricted network; and if a response is received from the user which corresponds to a decision to allow the communication device to access the restricted network, causing the communication device to be allowed to access the restricted network.

According to the present invention, there is also provided a method of controlling access to a restricted network, comprising: detecting an identifier of a communication device which is attempting to access the restricted network; determining whether a user should be queried about allowing the communication device to access the restricted network; if the determining is that a user should be queried, causing the user to be queried regarding access of the communication device to the restricted network; and if an indication is received that the queried user desires to allow the communication device access to the restricted network, allowing the communication device to access the restricted network.

According to the present invention there is further provided, a system for managing access to a restricted network, comprising: means for indicating to a user that a communication device is attempting to access the restricted network; and means, if a response is received from the user which corresponds to a decision to allow the communication device to access the restricted network, for causing the communication device to be allowed to access the restricted network.

According to the present invention there is yet further provided, a system for controlling access to a restricted network, comprising: means for receiving an identifier of a communication device which is attempting to access the restricted network; means for determining whether a user should be queried about allowing the communication device to access the restricted network; means for causing the user to be queried regarding access of the communication device to the restricted network, if the determining is that a user should be queried; and means for allowing the communication device to access the restricted network, if an indication is received that the queried user desires to allow the communication device access to the restricted network.

According to the present invention there is still further provided, a system for interactively controlling access to a restricted network, comprising: means for receiving an identifier of a communication device which is attempting to access the restricted network; means for determining whether a user should be queried about allowing the communication device to access the restricted network; means for indicating to a user that a communication device is attempting to access the restricted network; and means for allowing the communication device to access the restricted network, if an indication is received that the queried user desires to allow the communication device access to the restricted network.

### BRIEF DESCRIPTION OF THE DRAWINGS FIGURES

The invention is herein described, by way of example only, with reference to the accompanying drawings, wherein:

FIG. 1 is a block diagram of a configuration for interactive control of network access, according to an embodiment of the present invention;

FIG. 2 is a block diagram of an access screener, according to an embodiment of the present invention;

FIG. 3 is a block diagram of an interactive access interface, according to an embodiment of the present invention;

FIG. 4 is a flowchart of a method for controlling network access, according to an embodiment of the present invention;

FIG. 5 is a flowchart of a method for interacting with a user concerning network access, according to an embodiment of the present invention; and

FIG. 6 is a picture of the input and output user interfaces of the interactive access interface of FIG. 3, according to an embodiment of the present invention.

### DETAILED DESCRIPTION OF THE INVENTION

Described herein are embodiments of the current invention including methods and systems for interactive control of network access. As described below, the invention provides a simple and straight-forward way for a network owner/operator to control access of communications devices to the network without requiring sophisticated or complex decisions or actions. As will be seen, in at least one embodiment of the invention, the network operator is provided a simple graphical query, the answer to which is used to enable or disable access of a device to the network.

The principles and operation of interactive control of network access according to the present invention may be better understood with reference to the drawings and the accompanying description. All examples given below are non-limiting illustrations of the invention described and defined herein.

The term communication network as used below refers to any suitable combination of physical communication means and application protocol. Examples of physical means include, inter-alia: cable, optical (fiber), wireless (radio frequency), wireless (microwave), wireless (infra-red), twisted pair, coaxial, telephone wires, underwater acoustic waves, etc. Examples of application protocols include inter-alia Short Messaging Service Protocols, File Transfer Protocol (FTP), Telnet, Simple Mail Transfer Protocol (SMTP), Hyper Text Transport Protocol (HTTP), Simple Network Management Protocol (SNMP), Network News Transport Protocol (NNTP), Audio (MP3, WAV, AIFF, Analog), Video (MPEG, AVI, Quicktime, RM), Fax (Class 1, Class 2, Class 2.0), and tele/video conferencing. In some embodiments, a communication network can alternatively or in addition to be identified by the middle layers, with examples including inter-alia the data link layer (modem, RS232, Ethernet, PPP point to point protocol, serial line internet protocol-SLIP, etc), network layer (Internet Protocol-IP, User Datagram Protocol-UDP, address resolution protocol-ARP, telephone number, caller ID, etc.), transport layer (TCP, Smalltalk, etc), session layer (sockets, Secure Sockets Layer-SSL, etc), and/or presentation layer (floating points, bits, integers, HTML, XML, etc). For example the term “Internet” is often used to refer to a TCP/IP network. In some embodiments, a particular communication network includes one technology whereas in other embodiments a particular communication network includes a combination of technologies.

The term network adaptor as used below refers to a module made up of any combination of software, hardware and/or firmware in a communication device which is configured to connect the device to at least one type of communication network.

The term communication device as used below refers to any combination of software, hardware and/or firmware which includes a network adaptor that is configured to connect the device to at least one type of communication network. Examples of communication devices include inter-alia cellular phones, pagers, fax machines, telephones, desktop computers, laptop computers, other types of computers, personal digital assistants PDAs, etc. as appropriate to the applicable communication network.

The term restricted communication network as used below refers to any one or more appropriate communication networks to which access is controlled by an embodiment of the system of the current invention.

The term entry communication network as used below refers to any one or more appropriate communication networks through which a network adaptor attempts to access a restricted network whose access is controlled by an embodiment of the system of the current invention.

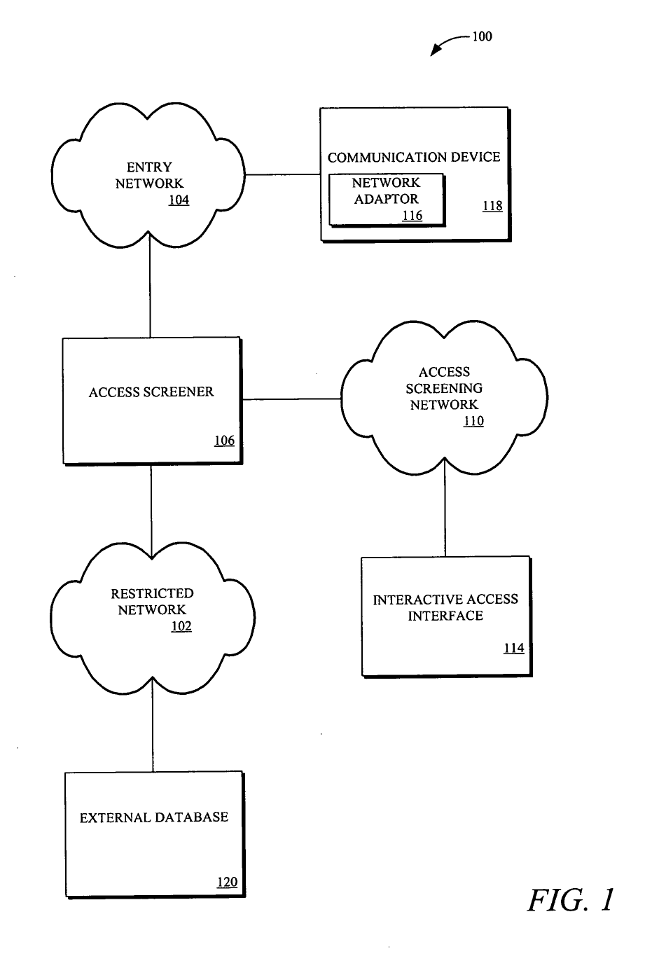

Referring now to the drawings, FIG. 1 illustrates a configuration 100 for interactive control of network access, according to an embodiment of the invention.

Configuration 100 includes one or more restricted communication networks 102, one or more entry communication networks 104, an access screener 106 which controls access by communication devices to restricted network(s) 102 via entry network(s) 104, one or more interactive access interfaces 114 for interacting with user(s) regarding communication devices which are attempting to access restricted network(s) 102, one or more optional access screening networks 110 linking access screener 106 with interactive access interface(s) 114, and optionally one or more external databases 120 which access screener 106 can access via restricted network 102. In one embodiment of the invention, the system of the invention for interactive control of network access includes access screener 106 and/or one or more interactive access interface 114.

For simplicity of description it is assumed that there is one restricted communication network 102, one entry communication network 104, one interactive access interface 114, one optional access screening network 110, and optionally one external database 120.

For simplicity of description only one communication device 118 including one network adaptor 116 is illustrated in FIG. 1 and described herein as attempting to access restricted network 102 via entry network 104.

In the described embodiments, data transmitted by communication device 118 can be identified as originating from communication device 118 based on one or more identifiers transmitted within the data or in association with the data. In some of these embodiments, the identifier(s) includes identifying information relating to network adaptor 116. For example, in one of these embodiments, the Media Access Control MAC address included in transmitted data may identify network adaptor 116 in accordance with certain specifications including inter-alia: Ethernet, Token ring, 802.11, Bluetooth, Fiber Distributed Data Interface FDDI, and Asynchronous Transfer Mode ATM. The MAC address can be for example: hard-wired on network adaptor 116, stored in a ROM of network adaptor 116 or changeable from software. In another embodiment, the unique clock skew of network packets, for example, can function instead or in addition as an identifier. In the description below for ease of explanation the singular form of identifier is used to include embodiments where one or more identifiers are used.

In the described embodiments, other identifying information refers to identifying information relating to communication device 118 which is not necessarily always transmitted within or in association with data originating from communication device 118, and therefore can not be relied upon to always identify data originating from communication device 118. For example, the other identifying information may only sometimes or never be transmitted within or in association with the transmitted data. Depending on the embodiment, some or all of the following other identifying information inter-alia may or may not be included in the transmitted data: the name of the owner/user, the email address of the owner/user, the phone number of the owner/user, the mailing address of the owner/user, the type of communication device, the model number of the communication device, the specifications of the communication device, the part number of the communication device, the computer name, the computer host name, the requested IP address, the assigned IP address, and the operating system type. It should be apparent to the reader that if any of the above listed identifying information is always transmitted within or in association with data in a particular embodiment, then in that particular embodiment that information would be considered an identifier instead.

In one embodiment, network adaptor 116 is an adaptor which is configured to connect communication device 118 including that adaptor 116 to a network conforming with any of the following specification inter-alia: Ethernet, Token ring, 802.11, Bluetooth, FDDI, and ATM. Continuing with the example, if entry network 104 is a wireless network, network adaptor 116 can be configured to connect via a wireless network. Still continuing with the example, if entry network 104 is instead a wired network, network adaptor 116 can be configured to connect via a wired network. For ease of explanation in the description below it is assumed that adaptor 116 conforms at least with Ethernet specifications however similar methods and systems to those described below can be used in embodiments where adaptor 116 conforms with other specifications, mutatis mutandis.

Optional access screening network 110 can be any suitable communication network. In one embodiment, access screening network 110 is the same communication network as restricted network 102 or as entry network 104 whereas in other embodiments access screening network 110 is a different communication network. In some embodiments access screening network 110 is secure. For example access screening network 110 may be secure by virtue of type, for example a wired network may be considered sufficiently secure in one embodiment. As another example access screening network 110 may alternatively or in addition be secure by virtue of encryption. Continuing with this example, usage of secure sockets layer SSL protocol or secure Hypertext Transfer Protocol HTTP protocol may be considered sufficiently secure in one embodiment regardless of whether access screening network 110 is wired or wireless.

Depending on the embodiment access screener 106 and interactive access interface 114 can communicate via access screening network 110 using any protocol or no protocol. For example, access screener 106 and interactive access interface 114 may communicate using HTTP, a proprietary protocol, etc.

In an embodiment where access screener 106 is integrated with interactive access interface 114, access screening network 110 may be omitted.

Optional external database 120 can be made up of any combination of software, hardware and/or firmware that performs the functions as defined and explained herein, typically storing information relating to network access of different devices. In some embodiments external database 120 includes none or some identifiers of trespassing communication devices which have been reported by users as attempting to access networks whose access is restricted. For example in one of these embodiments, even an identifier which has only been reported once is included as a trespasser in external database 120 whereas in another of these embodiments, only after an identifier has been reported a predetermined number of times and/or by more than one user is the identifier of the network adaptor included as a trespasser in external database 120. In some embodiments, external database 120 also or alternatively includes other identifying information corresponding to the identifiers. In one of these embodiments, the other identifying information and the corresponding identifiers are listed in the form of a look up table. In this embodiment the corresponding other identifying information can be listed only for identifiers of reported trespassing communication devices, or the corresponding other identifying information can be listed for any identifiers for which the corresponding other identifying information is available.

Access screener 106 can be made up of any combination of software, hardware and/or firmware that performs the functions as defined and explained herein, typically performing screening functions relating to devices attempting network access. In one embodiment, access screener 106 is integrated with one or more other network devices (the other network devices having additional network functionality). In another embodiment, access screener 106 is a standalone device. For example, assuming an embodiment where another network device joins entry network 104 with restricted network 102, access screener 106 can be integrated with the other network device or can be in a stand alone unit which is situated for example between the other network device and restricted network 102. Examples of other network devices include inter-alia: routers, proxy servers, firewalls, wireless access points, network switches, network hubs, and network bridges. Depending on the embodiment access screener 106 can be powered by any appropriate power source, for example a battery or an external power supply.

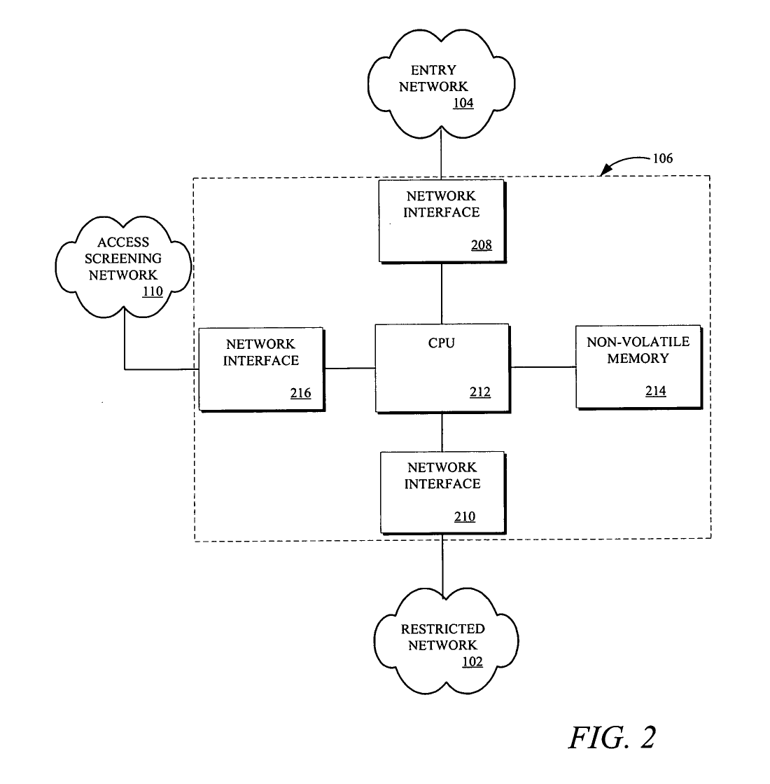

FIG. 2 is a block diagram of access screener 106 according to an embodiment of the present invention. In this embodiment, access screener 106 includes a network interface 208 configured to connect either directly or indirectly (i.e. indirectly via one or more other network devices) to entry network 104, a second network interface 210 configured to connect directly or indirectly (i.e. indirectly via one or more other network devices) to restricted network 102, a central processing unit CPU 212, a non-volatile memory 214, and a network interface 216 configured to connect directly or indirectly (i.e. indirectly via one or more other network devices) to access screening network 110., Each of modules 208, 210, 212, 214 and 216 can be made up of any combination of software hardware and/or firmware that performs the functions as defined and explained herein.

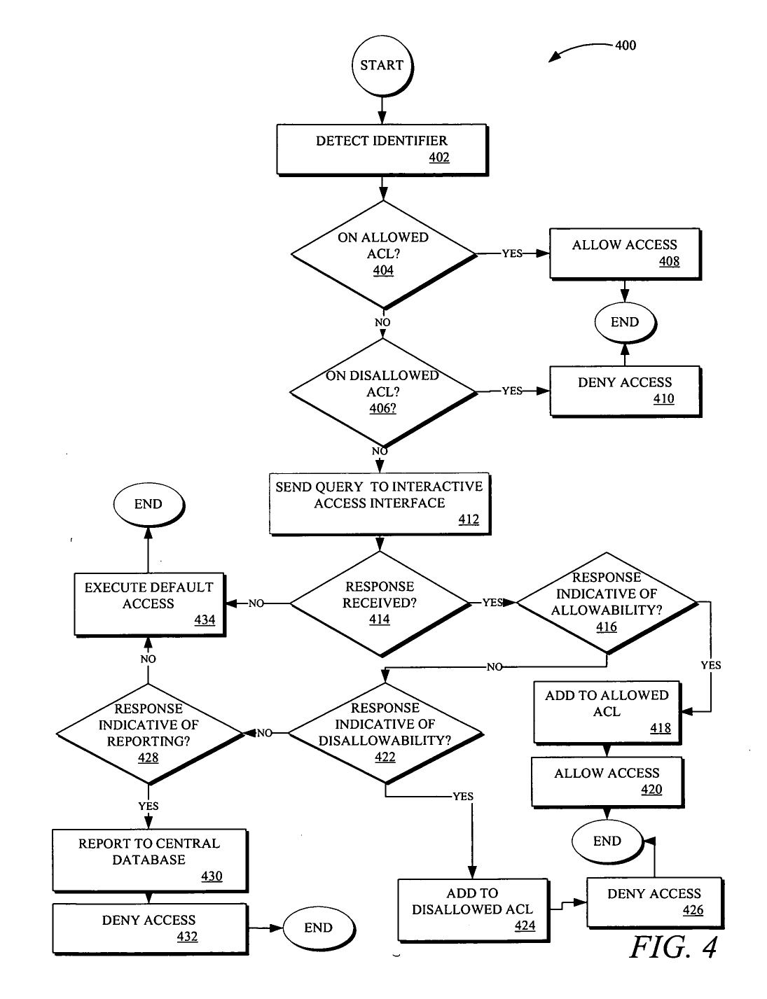

In one embodiment, network interfaces 208, 210, and 216 are Ethernet interfaces. In one embodiment, CPU 212 controls the flow of data between the network ports connected to each of interfaces 208 and 210, for example in accordance with method 400 described below with reference to FIG. 4.

In one embodiment, non-volatile memory 214 is any suitable memory with write ability which retains the contents within when power is turned off, e.g., electrically erasable programmable read only memory EEPROM, random access memory RAM powered with a battery, flash memory, semiconductor memory, magnetic memory, optical memory, etc.

For example in one embodiment, non-volatile memory 214 can store an access log. Depending on the embodiment, the log can include any information. For example, in one embodiment, the log can include one or more of the following inter-alia: the number of packets transmitted by each communication device as identified by the associated identifier thereof (for example to pinpoint abusive users), the date and time of last access and/or attempted access by each communication device as identified by the associated identifier thereof, and the number of times in a given period each identified communication device has accessed or attempted access.

In one embodiment, non-volatile memory 214 can store for example a list of the identifiers of communication devices whose access to restricted network 102 is known to be allowable or disallowable as will be explained in more detail below. The optional stored lists will be referred to below respectively as allowed access control list and disallowed access control list (with ACL used below as an acronym for access control list). In other embodiments, the optional stored list(s) can include other identifying information in addition to or instead of the identifiers. In one of these other embodiments a lookup table can also be stored in memory 214 to show the correspondence between the other identifying information and the identifiers. In this other embodiment, if access screener 106 receives the identifier, access screener 106 can use the lookup table to find the corresponding other identifying information stored in the lists and use this other identifying information for example when communicating with interactive access interface 114 and/or external database 120. In the description below it is assumed that any lists at least include the identifiers, but if other identifying information is listed instead of identifiers, similar methods and systems to those described below can be used mutatis mutandis.

Identifiers (and/or other identifying information) may have been put on one or more access control lists using any appropriate methods and systems. For example, some or all of the identifiers may have been put on one or more access control lists during previous executions of method 400 (see below FIG. 4). As another example, some or all of the identifiers could have been specified through another method, for example by accessing an identifier filtering page (for example a MAC filtering page) using a web browser.

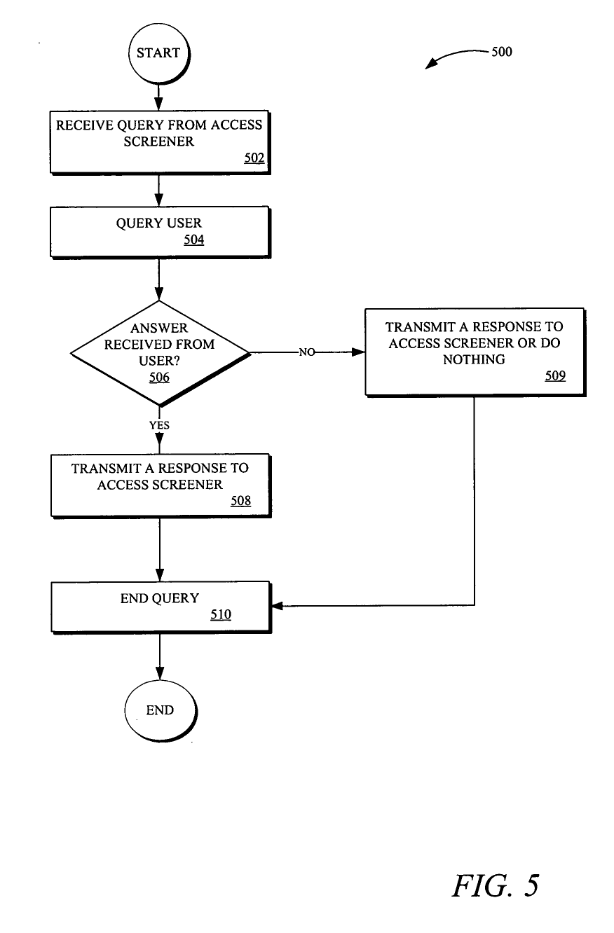

In some embodiments, access screener 106 also controls whether communication device 118 including network adaptor 116 is allowed/denied communication with other communication devices connected to communicate through entry network 104. In one embodiment, the same allowed access control list, the same disallowed access control list, and/or the same user response (see FIG. 5) decide whether communication device 118 is allowed/denied access to restricted network 102 and communication with other devices connected to entry network 104. For example if entry network 104 is a wireless network, in this embodiment the same allowed access control list, the same disallowed access control list, and/or the same user response (see FIG. 5) decides whether communication device 118 is allowed/denied access to restricted network 102 and communication with other devices connected to the wireless network.

In another embodiment, separate allowed and/or disallowed access control lists, and/or separate user responses decide whether communication device 118 is allowed/denied access to restricted network 102 and communication with other devices connected to entry network 104, or only allowed/denied communication with other devices connected to entry network 104. In another embodiment, separate allowed and/or disallowed access control lists, and/or separate user responses decide whether communication device 118 is allowed/denied access to restricted network 102 and communication with other devices connected to entry network 104, or only allowed/denied access to restricted network 102. In another embodiment, separate allowed and/or disallowed access control lists and/or separate user responses decide whether communication device 118 is allowed/denied access to restricted network 102, and separate allowed and/or disallowed access control lists and/or separate user responses decide whether communication device 118 is allowed/denied communication with other devices connected to entry network 104. For example a user may not mind if device 118 accesses restricted network 102 but the user may not want to allow device 118 to communicate with other devices on entry network 104. Continuing with the example, the user conversely may not mind if device 118 accesses other devices on entry network 104 but the user may not want to allow device 118 to access restricted network 102.

For simplicity of description in the description below it is assumed that the same optional allowed and/or disallowed access control lists and the same user response decides whether communication device 118 is allowed/denied access to restricted network 102 and allowed/denied communication with other devices connected to entry network 104. Therefore it is assumed in the description that if communication device 118 is allowed or denied access to restricted network 102, communication device 118 is also allowed or denied communication with other devices connected to entry network 104. In embodiments where separate allowed and/or disallowed access control lists and/or separate user responses (i.e. separate from lists and responses pertaining to access to restricted network 102) decide whether communication device 118 is allowed or denied communication with other devices connected to entry network 104, similar methods and systems to those described here can be used, mutatis mutandis.

In alternative embodiments, there may be more than one allowed access control list and/or disallowed access control list involving different levels of permissible access to restricted network 102 and/or different levels of permissible communication with devices connected to entry network 104. For example one allowed access control list can involve short duration access (for instance allow communication device 118 to access restricted network 102 for a maximum duration of ten minutes), whereas another access control list involves long duration access (for instance allow communication device 118 to access restricted network 102 for an unlimited duration). As another example, one allowed access control list may involve access to anywhere on restricted network 102 whereas another allowed access control list involves access to limited parts of restricted network 102. Similarly in these embodiments, the same user response may not necessarily apply to all levels of access/communication and therefore permission may be requested from the user separately for one or more levels. For ease of description it is assumed below that there is only one level of permissible access/communication (and therefore only one corresponding optional allowed access list and/or disallowed access list and/or user response). However in alternative responses with more than one access/communication level, similar methods and systems to those described here can be used, mutatis mutandis.

In one embodiment, it is assumed that access screener 106 is configured so that as a default a particular communication device is not permitted to access restricted network 102 unless an identifier of that particular communication device (and/or other corresponding identifying information) is on the allowed access control list and/or is allowed by the user through interactive access interface 114 in method 500 (see below). In another embodiment, access screener 106 is configured so that as a default, a particular communication device is permitted to access restricted network 102 unless an identifier of that particular communication device (and/or other corresponding identifying information) is on the disallowed access control list and/or is denied by the user through interactive access interface 114 in method 500 (see below). In yet another embodiment, access may be allowed or denied as a default based on the circumstances in effect.

In some embodiments of the invention, access screener 106 also includes a built-in network switch. In one of these embodiments, the network switch allows multiple network devices, such as for example multiple wireless access points, to be connected to entry network 104.

In some embodiments of the invention, access screener 106 is configured to detect malicious activity and/or attempted intrusions. In some of these embodiments, access screener 106 is configured to block the malicious activity and/or to inform one or more users of the malicious activity and/or intrusion, for example via interactive access interface 114. For example, in one of these embodiments access screener 106 is configured to detect MAC address spoofing, for example using some or all of the techniques described in “Detecting Wireless LAN MAC Address Spoofing” by Joshua Wright and/or described in “Wireless Intrusion Detection and Response” by Timothy R. Schmoyer et al, Details of each of these publications are incorporated by reference herein. Other examples of malicious activity which in some embodiments may be detected, blocked and/or reported to users by access screener 106 include inter-alia: SYN attack, DOS (denial of service) attack, IP address spoofing, and port scanning.

The division of access screener 106 into the modules shown in FIG. 2 is for ease of understanding and in other embodiments any of the modules may be separated into a plurality of modules or alternatively combined with any other module(s). For example, in an embodiment where access screening network 110 is integrated with restricted network 102, the functionality of network interface 210 and network interface 216 may be combined together.

As mentioned above, in some embodiments access screener 106 may be integrated with one or more other network devices., and therefore one or more of the modules shown in FIG. 2 may in these embodiments be integrated with modules of these one or more other network devices.

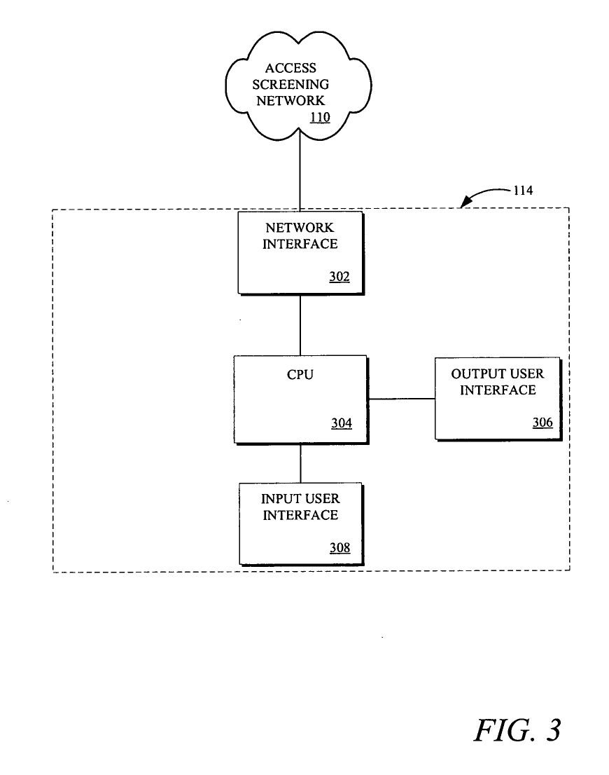

FIG. 3 is a block diagram of interactive access interface 114, according to an embodiment of the present invention. In this embodiment, interactive access interface 114 includes a network interface 302 configured to connect to access screening network 110, an output user interface 306, an input user interface 308, and a CPU 304. Each of modules 302, 304, 306 and 308 can be made up of any combination of software hardware and/or firmware that performs the functions as defined and explained herein. Interactive access interface 114 can be powered by any suitable power source, for example by a battery or by an external power source.

Output user interface 306 is configured to provide to a user the identifiers of communication devices which are attempting to access restricted network 102 via entry network 104 and/or to provide other corresponding identifying information. Optionally output user interface 306 can also provide other output to the user. Output user interface 306 may be configured to provide any of the above visually, using sound any/or by any other techniques. For example, output interface 306 can include a display, and/or a speaker.

Input user interface 308 is configured to receive a decision from a user on whether to allow the identified communication devices to access restricted network 102 via entry network 104 (and optionally configured to receive other input from a user). For example, input interface 308 in one embodiment can allow a selection among at least two options including allowing access and denying access. Continuing with the example, input interface 308 can include buttons, a touch-screen, menus, a keyboard, a mouse, a stylus, a microphone, etc. Still continuing with the example, in one embodiment, input users interface 308 can include at least four buttons, representing allow access (for example “yes”), deny access (for example “no”), no-decision (for example “ignore”), and report attempt to gain access (for example “report”).

The division of interactive access interface 114 into the modules shown in FIG. 3 is for ease of understanding and in other embodiments any of the modules may be separated into a plurality of modules or alternatively combined with any other module(s).

Depending on the embodiment, interactive access interface 114 may be a stand-alone device or may be integrated into another communication device with additional functionality (for example additional computing, networking, inputting, outputting, etc. capabilities). For example in one embodiment, interactive access interface 114 can be software running on a communication device with additional functionality. If integrated into another communication device, the modules of interactive access interface 114 may be integrated with modules of the other device.

In an alternative embodiment the modules shown in FIGS. 2 and 3 may be distributed differently among access screener 106 and interactive access interface 114. For example, memory 214 may be split between access screener 106 and interactive access interface 114 or wholly in interactive access interface 114.

As mentioned above, in some embodiments, access screener 106 may be integrated with interactive access interface 114. For example in one of these embodiments, CPU 212 may be integrated with CPU 304 and network interfaces 216 and 302 may be omitted. As another example, access screener 106 and interactive access interface 114 may both be integrated into another network device. Continuing with the example, in one embodiment access screener 106 and interactive access interface 114 may both be integrated into a wireless access point, and optionally one or more other interactive access interfaces 114 may be separated from the integrated wireless access point. In the description, it is assumed that access screener 106 and interactive access interface 114 are separate from one another, but in embodiments where access screener 106 and interactive access interface 114 are integrated together, similar methods and systems to those described here can be used, mutatis mutandis.

FIG. 4 illustrates a flowchart of a method 400 for controlling access to restricted network 102, according to an embodiment of the present invention. Method 400 is performed by access screener 106. It is assumed that communication device 118 (with network adaptor 116) accesses restricted network 102 via entry network 104. In one embodiment method 400 is repeated each time data transmitted by communication device 118 is intercepted by access screener 106, with access screener 106 allowing or denying access to restricted network 102. In this embodiment, communication device 118 is allowed or denied access to restricted network when access screener 106 respectively passes along or blocks data originating from communication device 118. For example method 400 may be repeated each time a data packet originating from communication device 118 passes through access screener 106 (both during the initial attempt at connection to restricted network 102 and once connection has been achieved). The invention is not bound by the specific stages or order of the stages illustrated and discussed with reference to FIG. 4. It should also be noted that alternative embodiments can include only selected stages from the illustrated embodiment of FIG. 4 and/or additional stages not illustrated in FIG. 4.

In some embodiments, restricted network 102 has other security measures employed to restrict access to restricted network 102. In one of these embodiments, method 400 is not executed unless communication device 118 passes the other security measures. In another of these embodiments, method 400 is executed simultaneously or before the other security measures.

In stage 402 access screener 106 receives an identifier of communication device 118. The received identifier can be any suitable identifier which allows identification of data originating from communication device 118 as discussed above.

For example in one embodiment the identifier includes a MAC address. Continuing with the example and assuming this round of method 400 is executed when communication device 118 is initially attempting to connect to restricted network 102, network adaptor 116 sends out a broadcast Dynamic Host Configuration Protocol DHCP request in order to find a DHCP server (i.e. in order to receive the internet protocol IP address of the DHCP server), in order to be assigned an internet protocol IP address, and/or in order to receive other configuration settings. As will be understood by the reader, the DHCP request includes the MAC address of network adaptor 116, and the DHCP server can be located anywhere on restricted network 102. Continuing with the example in stage 402 access screener 106 intercepts the DHCP request, extracts the MAC address, and blocks the DHCP request if and until connection by communication device 118 to restricted network 102 is allowed in accordance with the remaining stages of method 400. If connection is allowed then in subsequent repetitions of method 400 (after the initial DHCP request), access screener 106 extracts in stage 402 the MAC address from the MAC address header included in any data transmitted by communication device 118, and allows or does not allow that data to reach the restricted network 102 in accordance with the remaining stages of method 400.

In some embodiments of the invention, access screener 106 checks for MAC address spoofing in stage 402, and if no spoofing is detected (or suspected), method 400 continues with the remaining stages of method 400. In one of these embodiments if spoofing is detected, access is denied and method 400 ends. In another of these embodiments if spoofing is detected, a user is also or alternatively informed via interactive access interface 114 and optionally given the opportunity to decide on how to proceed..

Assuming access screener 106 stores identifiers of communication devices which are known to be allowed to access restricted network 102 (i.e. on allowed access control list) and identifiers of communication devices which are known to not be allowed to access restricted network 102 (i.e. on disallowed access control list), optional stages 404 and 406 are executed.

In stage 404 access screener 106 determines if the received identifier is on the allowed access control list. If the identifier is on the allowed access control list then in stage 408 access screener 106 allows communication device 118 to access restricted network 102. Method 400 then ends.

If the received identifier is not on the allowed access control list then method 400 continues with stage 406.

If there is no stored allowed access control list then stage 404 can be omitted and method 400 proceeds directly to stage 406.

In stage 406 access screener 106 determines if the received identifier is on the disallowed access control list. If the received identifier is on the disallowed access control list then in stage 410 access screener 106 denies communication device 118 access to restricted network 102. Method 400 then ends.

If the received identifier is not on the disallowed access control list then method 400 continues with stage 412.

If there is no stored disallowed access control list then stage 406 can be omitted and method 400 proceeds directly to stage 412.

In some embodiments, access screener 106 in stage 406 also checks if the detected identifier (and/or other corresponding identifying information) is listed in external database 120 as matching that of a reported trespasser. Depending on the embodiment, the checking with external database 120 can be made each time data is intercepted by screener 106 (i.e. during any attempt to access) or only during the initial attempt at connection (for example when a DHCP request is intercepted). In one of these embodiments, if the identifier matches that of a reported trespasser, then access is denied in stage 410 and the method ends. In another of these embodiments, if the identifier matches that of a reported trespasser but the identifier is not on any list, the user is queried about whether to allow communication device 118 (see below stage 504). Optionally in this other embodiment, the user is informed in the query that the identifier matches that of a reported trespasser.

In other embodiments, identifiers of network adaptors are not stored by access screener 106 and stages 404 and 406 are omitted.

In other embodiments, even if network adaptor 116 is on the allowed access control list and/or the disallowed access control list, stage 412 may be executed in order to allow a user the opportunity to override a listing. For example in one of these embodiment, a user is given the opportunity to allow or deny permission to communication device 118 to access restricted network 102 (on a one-time basis or from this point forward) even if the identifier of network adaptor 116 is on the disallowed or allowed access control list. In others of these embodiments, only if the identifier of network adaptor 116 has one or more particular attributes, is the user given an opportunity to override the listing. For example in one of these other embodiments only if communication device 118 has not recently accessed restricted network 102 is the user given the opportunity to override the listing. Depending on the embodiment, the opportunity to override a listing may only be given during the attempt to connect by communication device 118 to restricted network 102 (for example when the DHCP request is intercepted) or at any stage during the connection when communication device 118 attempts access (for example when the DHCP request is intercepted and when any subsequent data is intercepted from communication device 118)

In stage 412 access screener 106 sends an indication via access screening network 110 to interactive access interface 114 that communication device 118 is trying to access restricted network 102. For example access screener 106 can transmit the identifier of communication device 118 and/or can transmit other identifying information (for example which may have been stored in memory 214 or in external database 120 and indexed to the identifiers) to interactive access interface 114.

The remainder of method 400 will be described in conjunction with a method for interacting with a network operator as described in process 500 of FIG. 5.

FIG. 5 illustrates a flowchart of method 500 for interacting with a user concerning access to restricted network 102, according to an embodiment of the present invention. Method 500 is performed by interactive access interface 114. It is again assumed that communication device 118 (including network adaptor 116) is attempting to access restricted network 102 via entry network 104. The invention is not bound by the specific stages or order of the stages illustrated and discussed with reference to FIG. 5. It should also be noted that alternative embodiments can include only selected stages from the illustrated embodiment of FIG. 5 and/or additional stages not illustrated in FIG. 5.

In stage 502 interactive access interface 114 receives the query relating to communication device 118 from access screener 106 via access screening network 110. For example the query can include the identifier of communication device 118 and/or other identifying information. In one embodiment, the query is only received if the identifier (and/or other identifying information) is neither on the allowed access control list nor on the disallowed access control list. In another embodiment, interactive access interface 114 receives the query regardless of whether the identifier (and/or other identifying information) is on one or both of the allowed/disallowed access lists or not. In yet another embodiment, interactive user interface 114 receives the query for the identifier and/or other identifying information which is listed on one or both of the allowed/disallowed access lists only if the identifier and/or other identifying information has certain attributes. In another embodiment, interactive user interface 114 receives the query for the identifier and/or other identifying information which is listed on one or both of the allowed/disallowed access lists only if communication device 118 is attempting to connect and has not yet been connected (see above the description of stage 412). Also depending on the embodiment, interactive user interface 114 may or may not receive the query if communication device 118 is listed in external database 120 as a reported trespasser.

In stage 504 the identifier of communication device 118 and/or other identifying information is provided to the user. The method of providing the identifier and/or other identifying information depends on the particular embodiment of output user interface 306. For example in one embodiment, output user interface 306 may provide a notice (for example by displaying) such as “Allow computer 00-06-25-53-CC-40 to access the network?” where 00-06-25-53-CC-40 is assumed to be an identifier of network adaptor 116, for example the MAC address. As mentioned above other data may be provided to the user, for example whether the identifier and/or other identifying information matches that of a reported trespasser.

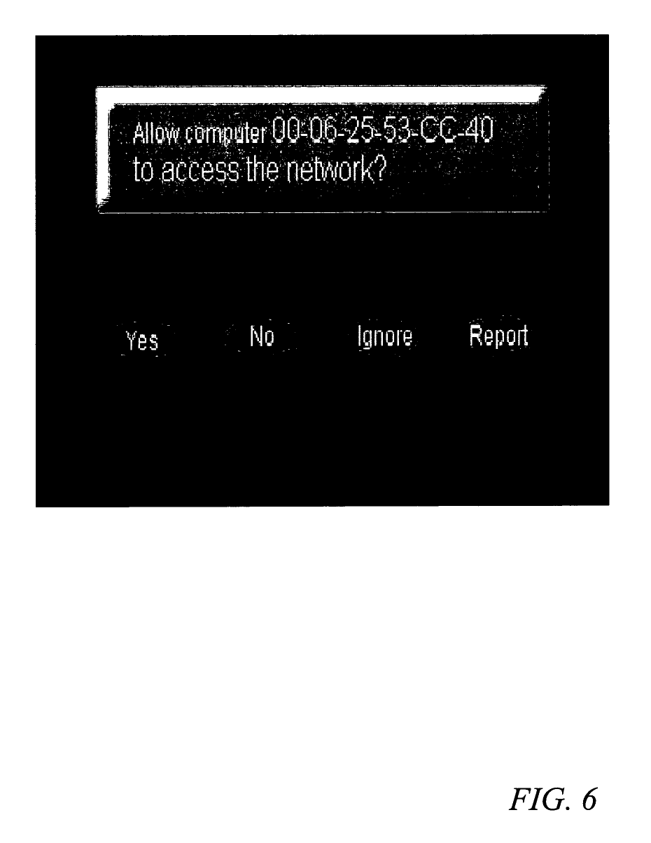

FIG. 6 illustrates an example of an output user interface 306 displaying a notice relating to the identifier of network adaptor 116, according to an embodiment of the present invention.

In one embodiment, in order to increase the likelihood that the user to whom the identifier and/or other identifying information is provided is one of one or more legitimate users who have the authority to decide if access should be granted to communication device 118, interactive access interface 114 is located where there is a high probability that a legitimate user receives the identifier/other identifying information (and not an illegitimate user). The legitimate user may have the authority to decide on access based on any recognized reason, for example because the user or agent thereof has installed access screener 106, because the user or agent thereof is paying for access to restricted network 102 via entry network 104, etc. For example, if interactive access interface 114 is a stand alone device, interactive access interface 114 can be located in a location frequented by the legitimate user(s) (as opposed to illegitimate people), for example home, office, etc. As another example if interactive access interface 114 includes software, the software can be installed on communication devices usually used by the legitimate user(s).

In one embodiment, in order to increase the likelihood that the identifier of communication device 118 and/or other identifying information is provided to the user in real time (i.e. as close as possible in time to when communication device 118 attempts to access restricted network 102) interactive access interface 114 is located where there is a high probability that a user will notice the identifier in real time. For example, if interactive access interface 114 is a stand-alone device, interface 114 may be located in a location where users spend a high proportion of time. As yet another example, more than one interactive access interface 114 may be configured to communicate with one access screener 106 in order to increase the likelihood of real time notification. For example more than one stand alone interactive access interfaces 114 may be installed or interactive access interface 114 may be integrated into more than one communication device of users. As another example, interactive access interface 114 may be installed on a wireless communication device which the user usually carries (In this case access screening network 110 would be wireless) or may be a stand-alone wireless device which the user can carry. In the description here for ease of explanation it is assumed that one interactive access interface 114 corresponds to one access screener 106 but in embodiments with more than one interactive access interface 114 per access screener 106 similar methods to those described here can be used mutatis mutandis.

As mentioned above, (other) identifying information other than the identifier of communication device 118 is also or alternatively provided to the user in stage 504. For example, access screener 106 may store other identifying information besides the identifier of communication device 118 for example stored on the allowed/disallowed access control list, and may provide this other identifying information in stage 412. As another example, access screener 106 may include a lookup table in memory 212 or external database 120 may include a lookup table of identifiers and other corresponding identifying information and when access screener 106 encounters an identifier, access screener 106 may look up the identifier in memory 212 or in database 120 and provide the corresponding other identifying information in stage 412. As another example, access screener 106 may only look up the corresponding other identifying information in external database 120 or memory 212 for an unknown identifier (i.e. not on any stored access control lists), for example in embodiments where the user is only queried for unknown identifiers. As another example, interactive access interface 114 may include a memory and when interactive access interface 114 receives an identifier in stage 502, interactive access interface 114 may look up the identifier in the memory thereof to retrieve other identifying information which is presented to the user in stage 504.

In stage 506, any user response is received by interactive access interface 114. Depending on the embodiment, the user can input any response appropriate for input user interface 308 of that embodiment. In some embodiments the user can only provide one response to each query whereas in other embodiments the user can provide more than one response. In some embodiments, the user can also input other data in stage 506 as described further below.

FIG. 6 also shows an example of input user interface 308, according to an embodiment of the present invention. In the embodiment illustrated in FIG. 6, there are four buttons, “yes”, “no”, ignore”, and “report”. In this embodiment, if the user selects the button “yes”, the selection is received in stage 506 and the selection or a function thereof is transmitted to access screener 106 in stage 508. When access screener 106 receives the selection or a function thereof in stage 414, access screener 106 recognizes the response as being indicative of allowability (stage 416), and therefore optionally adds the identifier of communication device 118 to the allowed access control list (stage 418), allows communication device 118 to access restricted network 102 (stage 420) and method 400 ends. In an embodiment where the user is queried even though the identifier is already on a list, if the user selected “yes” for an identifier on the disallowed access control list then access screener 106 may remove the identifier from the disallowed access control list and add the identifier to the allowed access control list in stage 418. In another embodiment where the user is queried even though the identifier is already on a list, the user may have the option of allowing or disallowing access to communication device 118 on a one-time basis and/or for a limited duration, and in this embodiment therefore stage 418 would be altered because the long-term position of the identifier on any list would not be affected by the decision of the user. In some other cases, stage 418 may be omitted for example if the user must be queried each time communication device 118 tries to access restricted network 102 (i.e. both for the attempt at connection and for subsequent transmission of data).

Continuing with the embodiment illustrated in FIG. 6, if the user selects the button “no”, the selection is received in stage 506 and the selection or a function thereof is transmitted to access screener 106 in stage 508. When access screener 106 receives the selection or a function thereof in stage 414, access screener 106 recognizes the response as being indicative of non-allowability (stage 422), and therefore optionally adds the identifier of communication device 118 to the disallowed access control list (stage 424), does not allow communication device 118 to access restricted network 102 (stage 426), and method 400 ends. In an embodiment, where the user is queried even though the identifier is already on a list, if the user selected “no” for an identifier on the allowed access control list then access screener 106 may remove the identifier from the allowed access control list and add the identifier to the disallowed access control list in stage 424. In another embodiment where the user is queried even though the identifier is already on a list, the user may have the option of allowing or disallowing access to communication device 118 on a one-time basis and/or for a limited duration, and in this embodiment therefore stage 424 would be altered because the long-term position of the identifier on any list would not be affected by the decision of the user. In some other cases, stage 424 may be omitted for example if the user must be queried each time communication device 118 attempts to access restricted network 102 (i.e. both for the attempt at connection and for subsequent transmission of data).

Continuing with the embodiment illustrated in FIG. 6, if the user selects the button “report”, the selection is received in stage 506 and the selection or a function thereof is transmitted to access screener 106 in stage 508. When access screener 106 receives the selection or a function thereof in stage 414, access screener 106 recognizes the response as being indicative of reporting (stage 428). Therefore access screener 106 reports the identifier of communication device 118 (and/or other identifying information which is known) to external database 120 as trespassing for example. The reporting can be made for example via restricted network 102 (stage 430). Access screener 106 does not allow communication device 118 to access restricted network 102 (stage 432) and method 400 ends. In some cases, the user may select the button “report” in conjunction with another button. For example the user may select the button “report” as well as the button “no” in order to both report the identifier and add the identifier to the disallowed list. In another embodiment, the identifier is also be added to the disallowed access control list as well as being reported in stage 430. In an embodiment where the user is queried even though the identifier is already on a list, if the user selected “report” for an identifier on the allowed access control list then access screener 106 may remove the identifier from the allowed access control list and add the identifier to the disallowed access control list in stage 430.

Continuing with the embodiment illustrated in FIG. 6, if the user selects the button “ignore” or alternatively does not respond to the query, the selection is received in stage 506 or a non-response is noted in stage 506 by interactive access interface 114. For example, interactive access interface 114 may include a timer (for example as part of CPU 304) and once a predetermined time has passed from stage 504 with no user response forthcoming, interactive access interface 114 may determine that a non-response has occurred. The selection (or non-response) or a function thereof is transmitted to access screener 106 in stage 508. Alternatively if no response is received from the user (or if an ignore response is received), interactive access interface 114 may not transmit a response to access screener 106 (stage 509). When access screener 106 receives the selection (or non-response) or a function thereof in stage 414 from interactive access interface 114, or alternatively does not receive a response in stage 414 from interactive access interface 114, access screener 106 recognizes there being an ignored query (stage 428). For example, access screener 106 may include a timer (for example as part of CPU 212) and may recognize that no response has been received once a predetermined time has passed from stage 412 without a response from interactive access interface 114. In stage 434 the default access is executed by access screener 106. The default access is the access allowed to communication device 118 if no user response is received or if the user response is “ignore”.

The default access of stage 434 can vary depending on the embodiment. In one embodiment in stage 434 screener 106 denies access for communication device 118 to restricted network 102 as the default access. In another embodiment, access screener 106 in stage 434 allows access for communication device 118 to restricted network 102 as the default access. In another embodiment, the default access depends on the particular circumstances. As an example of the latter embodiment, assume that the identifier is provided to the user even if the identifier is on the allowed access control list, then if there is an ignore response or no response the default may be in some cases to allow access to restricted network 102 when the identifier is on the allowed control list (i.e. in these cases access may only be denied to communication device 118 if the user selects “no” and/or “report” to override the allowed access control list) but to deny access under all other circumstances.

The default access in some embodiments may also include listing the identifier on the allowed access control list or on the disallowed access control list on a permanent or temporary basis.

In some embodiments, the user may have the option to input other identifying information relating to communication device 118 in stage 506.The inputted information may be stored, for example in access screener 116, in interactive access interface 114 and/or in external database 120 so that in subsequent times when communication device 118 attempts to access restricted network 102 the other identifying information can be presented to the user (and/or to other users) in addition to or instead of the identifier.

In optional stage 510, interactive access interface 114 ends the query, for example by stopping output user interface 306 from continuing to output the query. Continuing with the example, if output user interface 306 includes a display, the query can be cleared from the display.

In one embodiment, as mentioned above, access screening network 110 is secure so that interception of communications between access screener 106 and interactive access interface 114 by an illegitimate person is unlikely in stages 412/502 and 508/509/414.

In some embodiments, access screener 106 may retransmit the identifier of communication device 118 (and/or other identifying information) even after communication device 118 has been previously allowed access to restricted network 102 in order to query the user again about allowing access. For example, as mentioned above, in one embodiment the user may be queried each time data transmitted by communication device 118 is intercepted by access screener 106. As another example in one embodiment, the user may be queried again once communication device 118 has been connected for a pre-determined period of time. As another example in one embodiment, if communication device 118 has been allowed access because of an “ignore” response or no response, the user may in some cases be queried again to make a more active decision on access.

In one embodiment, a user can interactively correct a regretted decision on access using interactive access interface 114. For example, input user interface 308 may include additional selection tools (e.g. additional buttons, menu selections etc) with one of the selection tools allowing an “undoing” of a previous selection. Continuing with the example, assuming the user regrets having allowed access to restricted network for communication device 118, the user can select “undo the last action” and interactive access screener 114 can send an indication to access screener 106 to prevent any further access by communication device 118 to restricted network 102 In another embodiment, the user can alternatively correct a regretted decision through another method, for example by accessing an identifier filtering page (for example a MAC filtering page) using a web browser. Once the user has corrected the regretted decision, access screener 106 can treat subsequently intercepted data originating from communication device 118 in accordance with the corrections made by the user.

In some embodiments, a user can proactively control network access using interactive access interface 114. In one of these embodiments, input user interface 308 may allow a selection such as “show me all connected communication devices” and “disconnect this connected device”. In this embodiment, if the user selects “show me all connected devices”, interactive access interface 114 may send a request to access screener 106 to provide identifiers and/or other identifying information on all connected communication devices. For example, access screener 106 can check some or all of the IP addresses associated with MAC addresses on the allowed access control list using an Internet Control Message Protocol Echo Request (“ping”). Continuing with the example, access screener 106 may receive in response an Internet Control Message Protocol Echo Reply (“pong”) for all IP addresses of connected (checked) communication devices and access screener 106 can then provide the MAC addresses associated with the connected (checked) communication devices to interactive access interface 114. Once received, in this embodiment, interactive access interface 114 may provide the identifiers and/or other identifying information to the user. The user in this embodiment may then select any connected communication devices which should be disconnected. The selection may then be transmitted to access screener 106 which will prevent any further access by those communication devices. In alternative embodiments, the user can alternatively or also proactively control network access through another method, for example by accessing an identifier filtering page (for example a MAC filtering page) using a web browser.

As another example, input user interface 308 may include a selection such as “edit allowed access control list” and/or “edit disallowed access control list”. If the user selects an access control list to view, the selection may be transmitted to access screener 106 which will provide the list. The user may then edit the selected list by adding and/or deleting identifiers and/or other identifying information on the list. In another embodiment, the user can alternatively or also edit an access control list through another method, for example by accessing an identifier filtering page (for example a MAC filtering page) using a web browser.

As mentioned above in alternative embodiments, there may be more than one allowed access control list and/or disallowed access control list. In these embodiments, stages 404 and 406 may be repeated more than one time, corresponding to each list. For example in one embodiment, only if the identifier of communication device 118 is not on any list is stage 412 executed. Otherwise in this example, communication device 118 is allowed or denied access to restricted network 102 and/or communication with other devices on entry network 104 depending on which list(s) the identifier of communication device 118 appears on. In addition or alternatively in this example communication device 118 is allowed or denied access/communication at a particular level which depends on which list(s) the identifier of communication device 118 appears on.

Continuing with this example, if the identifier of communication device 118 is not on any list, the user may be queried in stage 504 whether to allow or deny access to restricted network 102 , whether to allow or deny communication with other devices connected to entry network 104, and if allowed at what particular level to allow access/communication. Depending on the user response/non-response in stage 506, access screener 106 sets access/communication for communication device 118 and optionally adds the identifier of communication device 118 to any appropriate access control lists. In another embodiment, stage 412 may be executed regardless of whether the identifier of communication device 118 is on any access control lists (or whether there are any access control lists), whenever access is attempted (i.e. during initial connection and during subsequent transmission of data). In this other embodiment, the user may be queried in stage 504 whether to allow or deny access to restricted network 102 , whether to allow or deny communication with other devices connected to entry network 104 and if allowed at what particular level to allow access/communication. Depending on the user response/non-response in stage 506, access screener 106 sets access/communication for communication device 118 and optionally adds/deletes the identifier of communication device 118 to any appropriate access control lists.

In an embodiment where information regarding access is logged, access screener 106 may log information relating to access at any appropriate stage of method 400.

In an embodiment where access screener 106 is configured to detect malicious activity and/or attempted intrusions as described above, access screener 106 may detect, block access and/or query the user via interactive access interface 114 regarding the malicious activity/attempted intrusion at any appropriate stage of method 400.

In embodiments where access screener 106 and interactive access interface 114 are integrated together, methods 400 and 500 may be combined together. For example one of these embodiments may use a combined method including stages 402 to 410, stage 504, stage 506 combined with stage 414, stage 510, and stages 416 to 434. In this embodiment, stages 412, 502, 508, and 509 may be omitted as these stages assume a separation between access screener 106 and interactive access interface 114.

While the invention has been described with respect to a limited number of embodiments, it will be appreciated that it is not thus limited and that many variations, modifications, improvements and other applications of the invention will now be apparent to the reader.

What is claimed is:

1. A method of managing access to a restricted network, comprising:
indicating to a user that a communication device is attempting to access the restricted network; and
if a response is received from said user which corresponds to a decision to allow said communication device to access the restricted network, causing said communication device to be allowed to access the restricted network.

2. The method of claim 1, wherein said indicating includes providing an identifier of a network adaptor of said communication device to said user.

3. The method of claim 2, wherein said identifier is a Media Access Control MAC address of said network adaptor.

4. The method of claim 1, wherein said communication device is attempting to access the restricted network via a wireless network.

5. The method of claim 1, further comprising: causing said communication device to be denied access to the restricted network if a response corresponding to a decision to allow said communication device to access the restricted network is not received from said user.

6. A method of controlling access to a restricted network, comprising:
detecting an identifier of a communication device which is attempting to access the restricted network;
determining whether a user should be queried about allowing said communication device to access the restricted network;
if said determining is that a user should be queried, causing said user to be queried regarding access of said communication device to the restricted network; and
if an indication is received that said queried user desires to allow said communication device access to the restricted network, allowing said communication device to access the restricted network.

7. The method of claim 6, wherein said determining includes: checking if said identifier is on an access control list and if said identifier is not on an access control list, deciding that said user should be queried.

8. The method of claim 7, wherein said identifier is on an allowed access control list and said determining is that a user should therefore not be queried, further comprising: allowing said communication device to access the restricted network.

9. The method of claim 7, wherein said identifier is on a disallowed access control list and said determining is that a user should therefore not be queried, further comprising: denying said communication device access to the restricted network.

10. The method of claim 6, further comprising: if no indication that said queried user desires to allow said communication device to access the restricted network is received, denying said communication device access to the restricted network.

11. The method of claim 6, further comprising: if an indication is received that said queried user desires to report said communication device as a trespasser, transmitting said identifier to an external database.

12. The method of claim 6, wherein said identifier is a Media Access Control (MAC) address of a network adaptor of said communication device.

13. The method of claim 6, wherein said communication device is attempting to access the restricted network via a wireless network.

14. A system for managing access to a restricted network, comprising:
means for indicating to a user that a communication device is attempting to access the restricted network; and
means, if a response is received from said user which corresponds to a decision to allow said communication device to access the restricted network, for causing said communication device to be allowed to access the restricted network.

14. The system of claim 14, further comprising:
means for receiving a response from said user.

15. The system of claim 14, wherein said system is located where there is a high probability of said user being a legitimate user and noticing said indicating in real time.

16. A system for controlling access to a restricted network, comprising:
means for receiving an identifier of a communication device which is attempting to access the restricted network;
means for determining whether a user should be queried about allowing said communication device to access the restricted network;
means for causing said user to be queried regarding access of said communication device to the restricted network, if said determining is that a user should be queried; and
means for allowing said communication device to access the restricted network, if an indication is received that said queried user desires to allow said communication device access to the restricted network.

17. The system of claim 16, further comprising: means for denying said communication device access to the restricted network if no indication is received that said queried user desires to allow said communication device access to the restricted network.

18. The system of claim 16, further comprising:
means for storing identifiers of communication devices for whom a decision on access may be made without querying said user.

19. The system of claim 16, wherein said system is integrated with a network device having additional functionality.

20. A system for interactively controlling access to a restricted network, comprising:
means for receiving an identifier of a communication device which is attempting to access the restricted network;
means for determining whether a user should be queried about allowing said communication device to access the restricted network;
means for indicating to a user that a communication device is attempting to access the restricted network; and
means for allowing said communication device to access the restricted network, if an indication is received that said queried user desires to allow said communication device access to the restricted network.

21. The system of claim 20, wherein any intra-system communication among means located apart is via a secure communication network.

22. The system of claim 20, further comprising: means for communicating with an external database regarding said identifier.

23. The system of claim 20, wherein said identifier is a Media Access Control MAC address of a network adaptor of said communication device.
